(19) United States
(12) Patent Application Publication
(10) Pub. No.: US 2025/0244161 A1
(43) Pub. Date: Jul. 31, 2025

(54) GRAIN YIELD MONITORING APPARATUS AND METHOD WITH FUNCTION OF MEASURING MOISTURE CONTENT

(71) Applicant: SHANDONG ACADEMY OF AGRICULTURAL MACHINERY SCIENCES, Jinan (CN)

(72) Inventors: Gang CHEN, Jinan (CN); Yitian SUN, Jinan (CN); Rui LI, Jinan (CN); Jingxin SHEN, Jinan (CN); Qinglong LI, Jinan (CN); Zhiqi ZHANG, Jinan (CN)

(21) Appl. No.: 19/073,332

(22) Filed: Mar. 7, 2025

Related U.S. Application Data
(63) Continuation of application No. PCT/CN2024/118181, filed on Sep. 11, 2024.

(30) Foreign Application Priority Data
Jan. 26, 2024 (CN) 2024101179332

(51) Int. Cl. G01F 25/10; A01D 41/127

(52) U.S. Cl. CPC G01F 25/14; A01D 41/1272

(57) ABSTRACT

Provided is a grain yield monitoring apparatus and method with a function of measuring moisture content, comprising a processor, a grain storage apparatus, a metering apparatus, and a counterweight apparatus. A grain yield monitoring method comprises: when a balance arm is in a balanced state, obtaining calibrated grain mass based on mass of a clump weight, and obtaining grain volume in the metering apparatus based on trigger position of arrays of photoelectric sensors; and obtaining measured grain mass of grain flowing through a flow sensor within a mass calibration time period based on a grain flow signal, calibrating grain mass based on an error between the calibrated grain mass and the measured grain mass to obtain a total grain yield, and obtaining a moisture content of grain based on the grain volume. The calibration of grain yield and measurement of moisture content of the grain can be synchronized.

### CROSS-REFERENCE TO RELATED APPLICATIONS

This patent application claims the priority of Chinese Patent Application No. 202410117933.2, entitled “GRAIN YIELD MONITORING APPARATUS AND METHOD WITH FUNCTION OF MEASURING MOISTURE CONTENT” filed with the China National Intellectual Property Administration on Jan. 26, 2024, the entire contents of which is incorporated by reference herein in its entirety as a part of the present application for all purposes.

### TECHNICAL FIELD

The present invention relates to the technical field of agricultural machinery intelligentization, in particular to a grain yield monitoring apparatus and method with a function of measuring moisture content.

### BACKGROUND

The statements herein only provide the background related to the present invention and do not necessarily constitute the prior art.

The yield monitoring system of a harvester is an important part of precision agriculture, and the yield map generated by the system in the later period is an important part of the work prescription map. At present, the yield measurement technology for grain harvesters mainly uses methods such as impulse type, weighing type, volumetric type, capacitive type, and photoelectric type to monitor the total amount of grain entering the warehouse. All of these methods are affected by calibration errors, errors in the moisture content and density of grain, sensor errors, machine vibration errors, etc.

Currently, the widely used yield measurement method is a yield measurement method using a weighing sensor. However, this method has many drawbacks. First, when the plots and the crop types are changed, multiple stops for calibration are required and are difficult in practical operation. Secondly, the bumpiness and vibration of the harvester during work have a great impact on the measured value of the weighing sensor, seriously affecting the measurement accuracy. Thirdly, it is unable to perform self-calibration when the grain density changes.

### SUMMARY

To solve the above problems, the present invention proposes a grain yield monitoring apparatus and method with a function of measuring moisture content. The moisture content of grain is measured while the grain yield is calibrated, which reduces the influence of bumpiness and slope of a harvester on the measurement accuracy. The grain yield monitoring apparatus has functions of self-calibrating a measured value of grain flow and measuring the moisture content.

To achieve the above objective, the present invention adopts the following technical solutions.

In a first aspect, the present invention provides a grain yield monitoring apparatus with a function of measuring moisture content, including a processor, a grain storage apparatus, a metering apparatus disposed below the grain storage apparatus, and a counterweight apparatus connected to the metering apparatus, wherein:
a flow sensor for detecting grain flow is provided on the grain storage apparatus;
arrays of photoelectric sensors are provided on the metering apparatus;
the counterweight apparatus includes a clump weight and a balance arm, and the clump weight and the metering apparatus are disposed on two sides of the balance arm respectively; and
the processor is configured to: when the balance arm is in a balanced state, obtain calibrated grain mass based on mass of the clump weight, and obtain grain volume in the metering apparatus based on a trigger position of the arrays of photoelectric sensors; and obtain measured grain mass of grain flowing through the grain storage apparatus within a mass calibration time period based on a grain flow signal, calibrate grain mass obtained by the flow sensor based on an error between the calibrated grain mass and the measured grain mass to obtain a total grain yield, and obtain a moisture content of the grain based on the grain volume, where the mass calibration time period is a time period from a start of a calibration until the balance arm is in the balanced state.

As an optional embodiment, the grain storage apparatus includes a grain storage cylinder provided with the flow sensor and a grain storage cylinder flap apparatus for opening and closing the grain storage cylinder; and the grain storage cylinder flap apparatus includes a grain storage cylinder flap motor, a grain storage cylinder flap, and a grain storage cylinder push-pull electromagnet, a rotating shaft of the grain storage cylinder flap is mounted on an outer wall of the grain storage cylinder and is connected to the grain storage cylinder flap motor, and the grain storage cylinder push-pull electromagnet is mounted at a bottom of the grain storage cylinder and is arranged at an angle of 90° with the rotating shaft of the grain storage cylinder flap to support and fix the grain storage cylinder flap.

As an optional embodiment, the metering apparatus includes a metering cylinder and a metering cylinder flap apparatus for opening and closing the metering cylinder; the metering cylinder is mounted on the balance arm, and the arrays of photoelectric sensors are mounted on a wall of a bell mouth of the metering cylinder at an angle of 90°; and
the metering cylinder flap apparatus includes a metering cylinder flap, a metering cylinder push-pull electromagnet, and a metering cylinder flap motor, a rotating shaft of the metering cylinder flap is mounted on an outer wall of the metering cylinder and is connected to the metering cylinder flap motor, and the metering cylinder push-pull electromagnet is mounted at a bottom of the metering cylinder and is arranged at an angle of 90° with the rotating shaft of the metering cylinder flap to support and fix the metering cylinder flap.

As an optional embodiment, at the start of calibration, the metering cylinder flap motor drives the metering cylinder flap to rotate to close the bottom of the metering cylinder, and a push rod of the metering cylinder push-pull electromagnet extends out to fix the metering cylinder flap;
after the arrays of photoelectric sensors generate a trigger signal, the grain storage cylinder flap motor drives the grain storage cylinder flap to rotate to gradually reduce an opening degree of the bottom of the grain storage cylinder;
when the balance arm is in the balanced state, the grain storage cylinder flap motor drives the grain storage cylinder flap to rotate to close the bottom of the grain storage cylinder, and the grain storage cylinder push-pull electromagnet fixes the grain storage cylinder flap;
after the calibration is completed, the push rod of the metering cylinder push-pull electromagnet is controlled to retract, and the metering cylinder flap motor drives the metering cylinder flap to rotate to open the bottom of the metering cylinder; and
after the grain in the metering cylinder is emptied, the push rod of the grain storage cylinder push-pull electromagnet is controlled to retract, and the grain storage cylinder flap motor drives the grain storage cylinder flap to rotate to open the grain storage cylinder.

As an optional embodiment, the counterweight apparatus further includes a support mechanism, and the support mechanism includes a support base, a support seat, a positioning plate, a support seat bearing, force sensors, dampers, support blocks, and contact switches;
the support seat is disposed on the support base, and the balance arm is connected to the support seat through the support seat bearing and makes a vertical motion with the support seat as a fulcrum;
the two dampers and the two force sensors are disposed between the support base and the balance arm; and
the positioning plate is mounted on a grain tank of a harvester and is opposite to the clump weight, the positioning plate is provided with the support block and the contact switch, and
one side of the support base opposite to the clump weight is provided with the support block and the contact switch.

As an optional embodiment, the balance arm is in the balanced state when values of the two force sensors are equal or within a set threshold range and the clump weight triggers the contact switch on the positioning plate; and
after the calibration is completed and the grain in the metering cylinder is emptied, the clump weight falls onto the support block of the support base and triggers the contact switch.

As an optional embodiment, if the flow sensor samples and measures an instantaneous cross-sectional area S of the grain flow passing through the grain storage apparatus at each sampling time interval Δt, then at the sampling time interval Δt, the measured grain mass M′ of the grain flowing through the grain storage apparatus is as follows: M′=gΔt²·ρS, where ρ is grain density of a working plot under the condition of ideal moisture content.

As an optional embodiment, if mass calibration is performed once at each time interval T and the number of samplings of the flow sensor is recorded as n′ within the mass calibration time period ΔT, then within the mass calibration time period ΔT, the total measured grain mass M_{T}′ obtained is as follows:

$${M}_{T}^{′} = {\sum }_{i = 1}^{{n}^{′}} g Δ {t}^{2} \cdot ρ {S}_{i} ,$$

where, Sᵢ represents an instantaneous cross-sectional area of the grain flow passing through the grain storage cylinder during i^{th} sampling of the flow sensor; and
determining whether to calibrate the grain mass obtained by sampling of the flow sensor within a certain time period before the calibration by judging a size between an error ΔM between the M_{T}′ and a calibrated mass m of the metering cylinder under the condition of the ideal moisture content, and a predetermined value M_{ER}, then the total grain yield M_{T} can be obtained as follows:

$${M}_{T} = {\sum }_{i = 1}^{{n}_{1}} {M}_{1 i} + {\sum }_{i = 1}^{{n}_{2}} {M}_{2 j} ,$$

where, n₁ is the total number of samplings of the flow sensor without calibration in a harvesting process; n₂ is the total number of samplings of the flow sensor with calibration in the harvesting process; M₁ᵢ represents a grain yield during i^{th} sampling without calibration; and M₂ⱼ represents a grain yield during j^{th} sampling with calibration.

As an optional embodiment, when the ΔM is less than or equal to the predetermined value M_{ER}, no calibration is performed; based on a recorded number n_{T1} of samplings of the flow sensor within the time period T before the calibration, the total number of samplings of the flow sensor within the mass calibration time period ΔT and the time period T before calibration is n′+n_{T1}, and a grain yield M₁ is as follows:

$${M}_{1} = {\sum }_{i = 1}^{{n}^{′} + {n}_{T 1}} g Δ {t}^{2} \cdot ρ {S}_{i} ,$$

when the ΔM is greater than the predetermined value M_{ER}, a grain yield within the time period T before the calibration is calibrated; the calibrated grain mass m is used as a grain yield within the mass calibration time period ΔT, and a calibration coefficient k_{ER} is as follows:

$${k}_{ER} = \frac{m}{{M}_{T}^{′}} ;$$

based on a recorded number n_{T2} of samplings of the flow sensor within the time period T before the calibration, a calibrated value M′_{C} of the grain yield within the time period T before the calibration is as follows:

$${M}_{C}^{′} = {k}_{ER} {\sum }_{i = 1}^{{n}_{T 2}} g Δ {t}^{2} \cdot ρ {S}_{i} ;$$

and, a grain yield M₂ within the mass calibration time period ΔT and the time period T before calibration is as follows:

$${M}_{2} = m + {M}_{C}^{′} .$$

As an optional embodiment, the moisture content of the grain obtained based on the grain volume is as follows:

$$\overline{w} = \frac{{\sum }_{i = 1}^{{n}_{w}} {w}_{i}}{{n}_{w}} ,$$

$$w = \frac{ρ {V}^{′} - m}{ρ {V}^{′}} \times 100 \% = \frac{{V}^{′} - V}{{V}^{′}} \times 100 \% ,$$

where, n_{w} is the total number of measurements of the moisture content of the grain; wᵢ is the moisture content of the grain measured for the i^{th} time; ρ is grain density of a working plot under the condition of ideal moisture content; V is grain volume of the working plot under the condition of the ideal moisture content; V′ is grain volume in a metering cylinder in the balanced state; and m is calibrated mass of the metering cylinder under the condition of the ideal moisture content.

In a second aspect, the present invention provides a grain yield monitoring method with a function of measuring moisture content, using the grain yield monitoring apparatus with a function of measuring moisture content in the first aspect, and including:
when the balance arm is in a balanced state, obtaining calibrated grain mass based on mass of the clump weight;
obtaining measured grain mass of grain flowing through the grain storage apparatus within a mass calibration time period based on a grain flow signal from the flow sensor, and calibrating grain mass obtained by the flow sensor based on an error between the calibrated grain mass and the measured grain mass to obtain a total grain yield, where the mass calibration time period is a time period from start of calibration until the balance arm is in the balanced state; and
when the balance arm is in the balanced state, obtaining grain volume in the metering apparatus based on a trigger position of the arrays of photoelectric sensors, and obtaining the moisture content of the grain based on the grain volume.

Compared with the prior art, the present invention has the following beneficial effects:

The present invention proposes a grain yield monitoring apparatus and method with a function of measuring moisture content. The grain flow is measured by the grain flow sensor, and the measured value of the grain flow sensor is calibrated at each time interval. The moisture content of the grain is measured while the grain yield is calibrated. Information on the moisture content of the grain and the grain yield can be detected. The monitoring apparatus provided by the present invention has the characteristics of a simple structural principle, self-calibration, being unaffected by the types of crops, and the like. It reduces the influence of bumpiness and slope of the harvester on the measurement accuracy, is less affected by environmental factors, has high measurement accuracy, enables real-time dynamic monitoring, and has the functions of self-calibrating the measured value and measuring the moisture content.

The additional aspects and advantages of the present invention will be partially given in the description below, and part of them will become apparent from the description below or will be learned from the practice of the present invention.

### BRIEF DESCRIPTION OF THE DRAWINGS

The accompanying drawings constituting a part of the present invention are used to provide further understanding of the present invention. The schematic embodiments of the present invention and their descriptions are used to explain the present invention and do not constitute an improper limitation to the present invention.

FIG. 1 is a front view of a grain yield monitoring apparatus with a function of measuring moisture content provided by Embodiment 1 of the present invention;

FIG. 2 is an axonometric view of a grain yield monitoring apparatus with a function of measuring moisture content provided by Embodiment 1 of the present invention; and

FIG. 3 is a partial sectional view of a grain yield monitoring apparatus with a function of measuring moisture content provided by Embodiment 1 of the present invention.

In the drawings: 1—support base; 2—support seat; 3—damper; 4—force sensor; 5—support block; 6—clump weight; 7—positioning plate; 8—contact switch; 9—balance arm; 10—support seat bearing; 11—metering cylinder; 12—flow sensor; 13—grain storage cylinder flap; 14—metering cylinder flap; 15—grain storage cylinder; 16—grain storage cylinder push-pull electromagnet; 17—grain storage cylinder flap motor; 18—stirring motor; 19—metering cylinder flap motor; 20—metering cylinder push-pull electromagnet; 21—array of photoelectric sensors; and, 22—stirrer.

### DETAILED DESCRIPTION

The present invention is further described below in conjunction with the accompanying drawings and examples.

It should be pointed out that the following detailed descriptions are all exemplary and are intended to provide further illustration of the present invention. Unless otherwise specified, all the technical and scientific terms used in the present invention have the same meanings as those commonly understood by those of ordinary skill in the art to which the present invention belongs.

It is to be noted that the terms used herein are only for describing specific examples, and are not intended to limit exemplary examples according to the present invention. As used herein, unless otherwise explicitly indicated in the context, the singular form is also intended to include the plural form. In addition, it should also be understood that the terms “include”, “including”, and any variation thereof are intended to cover non-exclusive inclusion. For example, processes, methods, systems, products or devices including a series of steps or units are not necessarily limited to clearly listed steps or units, but may include steps or units not clearly listed, or other steps or units inherent to these processes, methods, products or devices.

In the absence of a conflict, the embodiments in the present invention can be combined with the features in the examples.

### Example 1

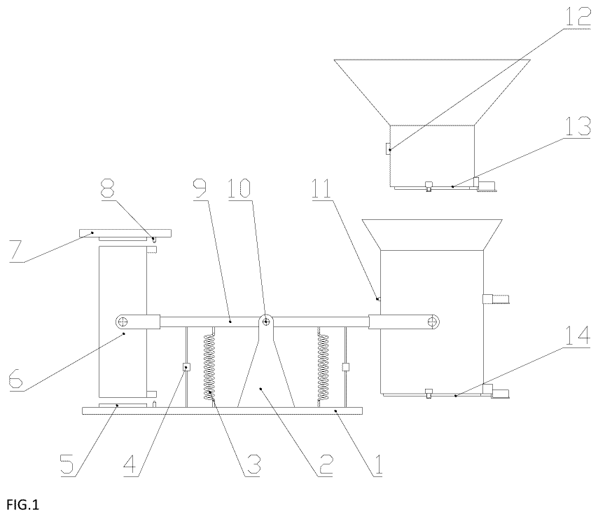

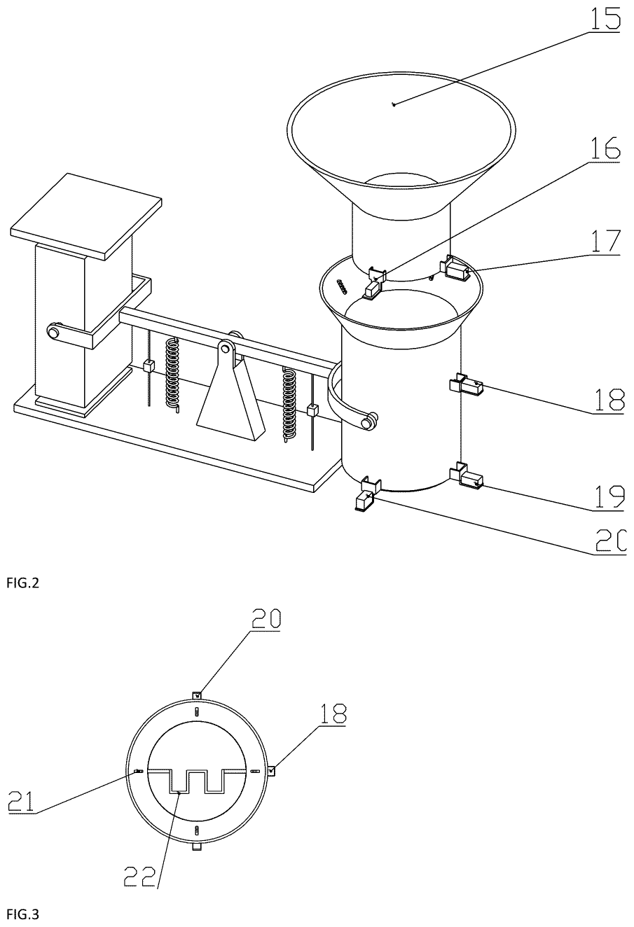

As shown in FIG. 1 and FIG. 2, the present example provides a grain yield monitoring apparatus with a function of measuring moisture content, including a processor, a grain storage apparatus, a metering apparatus disposed below the grain storage apparatus, and a counterweight apparatus connected to the metering apparatus, wherein,
a flow sensor for detecting grain flow is provided on the grain storage apparatus;
arrays of photoelectric sensors are provided on the metering apparatus;
the counterweight apparatus includes a clump weight and a balance arm, and the clump weight and the metering apparatus are disposed on two sides of the balance arm respectively; and
the processor is configured to: when the balance arm is in a balanced state, obtain calibrated grain mass based on mass of the clump weight, and obtain grain volume in the metering apparatus based on a trigger position of the arrays of photoelectric sensors; and obtain measured grain mass of grain flowing through the grain storage apparatus within a mass calibration time period based on a grain flow signal, calibrate grain mass obtained by the flow sensor based on an error between the calibrated grain mass and the measured grain mass to obtain a total grain yield, and obtain the moisture content of the grain based on the grain volume, where the mass calibration time period is a time period from start of calibration until the balance arm is in the balanced state.

In the present example, the grain storage apparatus is mounted on a grain harvester, and includes a grain storage cylinder 15, a grain storage cylinder flap apparatus, and the flow sensor 12;
the grain storage cylinder 15 is fixed to a grain warehouse, and the grain lifted and transported to the grain warehouse first enters the grain storage cylinder 15; and the flow sensor 12 is mounted on a sidewall of the grain storage cylinder 15, and the flow sensor uses a microwave detection method to detect the flow of the grain falling from the grain storage cylinder 15 and then calculates the mass of the grain that falls.

The grain storage cylinder flap apparatus is fixed to a bottom of the grain storage cylinder 15 and is configured to open and close the grain storage cylinder 15; and the grain storage apparatus includes a grain storage cylinder flap motor 17, a grain storage cylinder flap 13, and a grain storage cylinder push-pull electromagnet 16, a rotating shaft of the grain storage cylinder flap 13 is mounted on two bearings on an outer wall of the grain storage cylinder 15 and is connected to the grain storage cylinder flap motor 17, the grain storage cylinder push-pull electromagnet 16 as a fixing apparatus for the grain storage cylinder flap 13 is mounted at the bottom of the grain storage cylinder 15 and is arranged at an angle of 90° with the rotating shaft of the grain storage cylinder flap 13, and a push rod of the grain storage cylinder push-pull electromagnet 16 extends out to support and fix the grain storage cylinder flap 13.

In the present example, the metering apparatus includes a metering cylinder 11, a metering cylinder flap apparatus, and a stirring apparatus;
the metering cylinder 11 is mounted on the balance arm 9;
the metering cylinder flap apparatus has the same structure as the grain storage cylinder flap apparatus, is configured to open and close the metering cylinder 11, and includes a metering cylinder flap 14, a metering cylinder push-pull electromagnet 20, and a metering cylinder flap motor 19; and a rotating shaft of the metering cylinder flap 14 is mounted on two bearings on an outer wall of the metering cylinder 11 and is connected to the metering cylinder flap motor 19, the metering cylinder push-pull electromagnet 20 as a fixing apparatus for the metering cylinder flap 14 is mounted at a bottom of the metering cylinder 11 and is arranged at an angle of 90° with the rotating shaft of the metering cylinder flap 14, and a push rod of the metering cylinder push-pull electromagnet 20 extends out to support and fix the metering cylinder flap 14.

In the present example, as shown in FIG. 3, the stirring apparatus includes a stirring motor 18 and a stirrer 22, where the stirring motor 18 is fixed to the outer wall of the metering cylinder 11, the stirrer 22 is mounted on the two bearings on the outer wall of the metering cylinder 11 and is connected to the stirring motor 18, and the stirring motor 18 drives the stirrer 22 to rotate, so that the grain in the metering cylinder 11 is distributed more compactly and evenly, and a top end of a grain pile is smoother.

In the present example, two sets of arrays of photoelectric sensors 21 are arranged in total and are mounted on a wall of a bell mouth of the metering cylinder 11 at an angle of 90°.

In the present example, the counterweight apparatus further includes a support mechanism; the support mechanism is mounted on a grain tank of the harvester and includes a support base 1, a support seat 2, a positioning plate 7, a support seat bearing 10, force sensors 4, dampers 3, support blocks 5, and contact switches 8;
the support seat 2 is disposed on the support base 1, the balance arm 9 is connected to the support seat 2 through the support seat bearing 10, two ends of each of the two dampers 3 and two ends of each of the two force sensors 4 are connected to the support base 1 and the balance arm 9, the dampers 3 are configured to reduce or prevent up-and-down swinging of the balance arm 9 caused by bumpiness of the harvester, and the force sensors 4 are configured to measure a tensile force of the balance arm 9 on two sides of the support seat 2; the positioning plate 7 is mounted on the grain tank of the harvester and is opposite to the clump weight 6; the two contact switches 8 are mounted on the positioning plate 7 and the support base 1; one of the two support blocks 5 is mounted on the support base 1, and the other is mounted on the positioning plate 7, so as to buffer an impact force generated by up-and-down swinging of the clump weight 6; and
the clump weight 6 and the metering apparatus are mounted on two sides of the balance arm 9, and the balance arm is connected to the support seat 2 through the support seat bearing 10 and makes a vertical motion with the support seat 2 as a fulcrum.

In the present example, the grain yield and the moisture content of the grain can be measured by the above grain yield monitoring apparatus.

Specifically, the grain yield is measured by means of measurement by the flow sensor and calibration by the metering cylinder. The grain lifted and transported by the harvester first falls into the grain storage cylinder 15, and then falls into the grain tank through the metering cylinder 11. The falling process of the grain is regarded as a free-fall motion. At this time, both the grain storage cylinder flap 13 and the metering cylinder flap 14 are in an opened state.

The flow of the grain that falls (i.e., the mass of the grain that falls within a certain time) can be obtained from measured data of the flow sensor 12. Specifically, by a microwave detection method, the grain flow passing through the grain storage cylinder 15 is detected and sampled at each time interval Δt to obtain an instantaneous cross-sectional area S of the grain flow passing through the grain storage cylinder 15 at the current sampling moment. Thus, within the same sampling time interval Δt, a falling distance of the grain flow is: Δh=gΔt²; and within the sampling time interval Δt, the volume of the grain flow passing through the grain storage cylinder 15 is: V=gΔt². S. Based on the grain density p of a working plot under ideal moisture content measured before work, the mass M′ of the grain flow passing through the grain storage cylinder 15 at the sampling time interval Δt is obtained as follows:

$${M}^{′} = g Δ {t}^{2} \cdot ρ S .$$

The metering cylinder 11 calibrates a measured value of the flow sensor 12 at each time interval T. At the start of calibration, the metering cylinder flap motor 19 drives the metering cylinder flap 14 to rotate to close the bottom of the metering cylinder 11, the push rod of the metering cylinder push-pull electromagnet 20 extends out to fix the metering cylinder flap 14, and all the grain flowing through the grain storage cylinder 15 falls into and is temporarily stored in the metering cylinder 11;
after the arrays of photoelectric sensors 21 at the bell mouth of the metering cylinder generate a trigger signal, the grain storage cylinder flap motor 17 drives the grain storage cylinder flap 13 to rotate to gradually reduce an opening degree of the bottom of the grain storage cylinder 15, so as to slowly increase the amount of the grain falling into the metering cylinder 11;
When values of the two force sensors 4 on the balance arm 9 are equal or within a set threshold range and the clump weight 6 triggers the contact switch 8 on the positioning plate 7, the balance arm 9 reaches the balanced state. At this time, the grain storage cylinder flap motor 17 is controlled to rotate the grain storage cylinder flap 13 to close the bottom of the grain storage cylinder 15, and the grain storage cylinder push-pull electromagnet 16 fixes the grain storage cylinder flap 13, so that the grain is temporarily stored in the grain storage cylinder 15.

When the balance arm is in the balanced state, the mass of the clump weight 6 (indicated as “cw” in subscript hereinafter) is equal to a sum of the mass of the grain in the metering cylinder 11 (indicated as “mc” in subscript hereinafter) and the mass of the metering cylinder 11 and its auxiliary components, that is, m_{cw}=m_{mc}+m, where m is calibrated mass of the grain in the metering cylinder under the condition of the ideal moisture content, and m_{mc} is the mass of the metering cylinder and its auxiliary components.

After two ends of the balance arm 9 are balanced, the stirring motor 18 in the metering cylinder rotates for a certain time period; after the signal from the arrays of photoelectric sensors is stable, the push rod of the metering cylinder push-pull electromagnet 20 is controlled to retract, and the metering cylinder flap motor 19 opens the bottom of the metering cylinder, so that the grain in the metering cylinder falls into the grain warehouse; and after the grain in the metering cylinder is emptied, the clump weight 6 falls onto the support block 5 and triggers the contact switch 8 on the support base 1, the trigger signal enables a controller to control the push rod of the grain storage cylinder push-pull electromagnet 16 to retract, and the grain storage cylinder flap motor 17 opens the bottom of the grain storage cylinder 15. At this time, the metering cylinder completes one calibration process.

When the number of samplings of the flow sensor within the mass calibration time period ΔT from closing of the bottom of the metering cylinder 11 to closing of the bottom of the grain storage cylinder 15 is recorded as n′, the final total yield M_{T}′ of the grain that falls into the metering cylinder is obtained as follows:

$${M}_{T}^{′} = {\sum }_{i = 1}^{{n}^{′}} g Δ {t}^{2} \cdot ρ {S}_{i} ,$$

where, Sᵢ represents an instantaneous cross-sectional area of the grain flow passing through the grain storage cylinder during i^{th} sampling of the flow sensor.

When the error ΔM between M_{T}′ and m is less than or equal to a predetermined value M_{ER}, that is, ΔM=|M_{T}′−m|≤M_{ER}, no calibration is performed on the measured value of the flow sensor within the mass calibration time period ΔT and a certain time period T before calibration; based on the recorded number n_{T1} of samplings of the flow sensor within a certain time period T before calibration, the total number of samplings of the flow sensor within the time period ΔT+T is n′+n_{T1}, and a grain yield M₁ is as follows:

$${M}_{1} = {\sum }_{i = 1}^{{n}^{′} + {n}_{T 1}} g Δ {t}^{2} \cdot ρ {S}_{i} ;$$

when the error ΔM between M_{T}′ and m is greater than the predetermined value M_{ER}, that is, ΔM=|M_{T}′−m|>M_{ER}, the calibrated mass m of the metering cylinder is used as a grain yield within ΔT, and the measured value of the flow sensor is calibrated by a calibration coefficient k_{ER} that is as follows:

$${k}_{ER} = \frac{m}{{M}_{T}^{′}} ;$$

if the flow sensor performs sampling and measurement for n_{T2} times within the time interval T before calibration, a calibrated value M_{C}′ of the grain yield within the time interval T is as follows:

$${M}_{C}^{′} = {k}_{ER} {\sum }_{i = 1}^{{n}_{T 2}} g Δ {t}^{2} \cdot ρ {S}_{i} ;$$

and, a grain yield M₂ within the time period ΔT+T is as follows:

$${M}_{2} = m + {M}_{C}^{′} = m + {k}_{ER} {\sum }_{i = 1}^{{n}_{T 2}} g Δ {t}^{2} \cdot ρ {S}_{i} .$$

Thus, the total grain yield M_{T} in a harvesting process is as follows:

$${M}_{T} = {\sum }_{i = 1}^{{n}_{1}} {M}_{1 i} + {\sum }_{i = 1}^{{n}_{2}} {M}_{2 j} ,$$

where, n₁ is the total number of samplings of the flow sensor without calibration in a harvesting process; n₂ is the total number of samplings of the flow sensor with calibration in the harvesting process; M₁ represents a grain yield during i^{th} sampling without calibration; and M₂ⱼ represents a grain yield during j^{th} sampling with calibration.

Further, a moisture content of the grain can be measured while the metering cylinder calibrates the measured value of the flow sensor. A product of the grain density p of the working plot under the condition of the ideal moisture content and the grain volume V is the calibrated grain mass m of the clump weight. The grain in different plots has different moisture content, so that the calibrated grain mass m of the clump weight also varies. The calibrated grain mass m can be adjusted by adding or reducing magnetic steel.

The stirring motor 18 drives the stirrer 22 to rotate, so that the top end of the grain pile in the metering cylinder is smoother. After the bottom of the grain storage cylinder is closed, under the action of stirring, when the signal from the two sets of the arrays of photoelectric sensors 21 is stable, grain volume V′ in the metering cylinder is calculated based on the position of the triggered arrays of photoelectric sensors.

In the balanced state of the clump weight and the metering cylinder, due to the moisture content, the grain volume V′ in the metering cylinder 11 when the calibrated grain mass m is reached is greater than the grain volume V in the metering cylinder 11 under the condition of the ideal moisture content, so the moisture content w of the grain measured once is as follows:

$$w = \frac{ρ {V}^{′} - m}{ρ {V}^{′}} \times 100 \% = \frac{{V}^{′} - V}{{V}^{′}} \times 100 \% ,$$

where, ρ is grain density of a working plot under the condition of ideal moisture content; V is grain volume of the working plot under the condition of the ideal moisture content; V′ is grain volume in a metering cylinder in the balanced state; and m is calibrated mass of the metering cylinder under the condition of the ideal moisture content, and m=ρV.

Thus, the average moisture content of the grain in a harvested plot is as follows:

$$\overline{w} = \frac{{\sum }_{i = 1}^{{n}_{w}} {w}_{i}}{{n}_{w}} ,$$

where n_{w} is the total number of moisture content measurements.

### Example 2

The present example provides a grain yield monitoring method with a function of measuring moisture content, using the grain yield monitoring apparatus with a function of measuring moisture content according to Example 1, and including:
when the balance arm is in a balanced state, obtaining calibrated grain mass based on mass of the clump weight;
obtaining measured grain mass of grain flowing through the grain storage apparatus within a mass calibration time period based on a grain flow signal from the flow sensor, and calibrating grain mass obtained by the flow sensor based on an error between the calibrated grain mass and the measured grain mass to obtain a total grain yield, where the mass calibration time period is a time period from start of calibration until the balance arm is in the balanced state; and
when the balance arm is in the balanced state, obtaining grain volume in the metering apparatus based on a trigger position of the arrays of photoelectric sensors, and obtaining the moisture content of the grain based on the grain volume.

While the specific embodiments of the present invention have been described above with reference to the accompanying drawings, they are not intended to limit the scope of protection of the present invention. It should understand by those skilled in the art that various modifications or transformations that can be made by those skilled in the art based on the technical solutions of the present invention without creative efforts are still within the scope of protection of the present invention.

1. A grain yield monitoring apparatus with a function of measuring moisture content, comprising a processor, a grain storage apparatus, a metering apparatus disposed below the grain storage apparatus, and a counterweight apparatus connected to the metering apparatus, wherein a flow sensor for detecting grain flow is provided on the grain storage apparatus;
arrays of photoelectric sensors are provided on the metering apparatus;
the counterweight apparatus comprises a clump weight and a balance arm, and the clump weight and the metering apparatus are disposed on two sides of the balance arm respectively; and
the processor is configured to:
when the balance arm is in a balanced state, obtain calibrated grain mass based on mass of the clump weight, and obtain grain volume in the metering apparatus based on a trigger position of the arrays of photoelectric sensors; and obtain measured grain mass of grain flowing through the grain storage apparatus within a mass calibration time period based on a grain flow signal, calibrate grain mass obtained by the flow sensor based on an error between the calibrated grain mass and the measured grain mass to obtain a total grain yield, and obtain a moisture content of the grain based on the grain volume, wherein the mass calibration time period is a time period from a start of a calibration until the balance arm is in the balanced state.

2. The grain yield monitoring apparatus with a function of measuring moisture content according to claim 1, wherein the grain storage apparatus comprises a grain storage cylinder provided with the flow sensor and a grain storage cylinder flap apparatus for opening and closing the grain storage cylinder; and the grain storage cylinder flap apparatus comprises a grain storage cylinder flap motor, a grain storage cylinder flap, and a grain storage cylinder push-pull electromagnet, a rotating shaft of the grain storage cylinder flap is mounted on an outer wall of the grain storage cylinder and is connected to the grain storage cylinder flap motor, and the grain storage cylinder push-pull electromagnet is mounted at a bottom of the grain storage cylinder and is arranged at an angle of 90° with the rotating shaft of the grain storage cylinder flap to support and fix the grain storage cylinder flap.

3. The grain yield monitoring apparatus with a function of measuring moisture content according to claim 1, wherein the metering apparatus comprises a metering cylinder and a metering cylinder flap apparatus for opening and closing the metering cylinder; the metering cylinder is mounted on the balance arm, and the arrays of photoelectric sensors are mounted on a wall of a bell mouth of the metering cylinder at an angle of 90°; and
the metering cylinder flap apparatus comprises a metering cylinder flap, a metering cylinder push-pull electromagnet, and a metering cylinder flap motor, a rotating shaft of the metering cylinder flap is mounted on an outer wall of the metering cylinder and is connected to the metering cylinder flap motor, and the metering cylinder push-pull electromagnet is mounted at a bottom of the metering cylinder and is arranged at an angle of 90° with the rotating shaft of the metering cylinder flap to support and fix the metering cylinder flap.

4. The grain yield monitoring apparatus with a function of measuring moisture content according to claim 2, wherein
at the start of the calibration, the metering cylinder flap motor drives the metering cylinder flap to rotate to close the bottom of the metering cylinder, and a push rod of the metering cylinder push-pull electromagnet extends out to fix the metering cylinder flap;
after the arrays of photoelectric sensors generate a trigger signal, the grain storage cylinder flap motor drives the grain storage cylinder flap to rotate to gradually reduce an opening degree of the bottom of the grain storage cylinder;
when the balance arm is in the balanced state, the grain storage cylinder flap motor drives the grain storage cylinder flap to rotate to close the bottom of the grain storage cylinder, and the grain storage cylinder push-pull electromagnet fixes the grain storage cylinder flap;
after the calibration is completed, the push rod of the metering cylinder push-pull electromagnet is controlled to retract, and the metering cylinder flap motor drives the metering cylinder flap to rotate to open the bottom of the metering cylinder; and
after the grain in the metering cylinder is emptied, the push rod of the grain storage cylinder push-pull electromagnet is controlled to retract, and the grain storage cylinder flap motor drives the grain storage cylinder flap to rotate to open the grain storage cylinder.

5. The grain yield monitoring apparatus with a function of measuring moisture content according to claim 1, wherein the counterweight apparatus further comprises a support mechanism, and the support mechanism comprises a support base, a support seat, a positioning plate, a support seat bearing, force sensors, dampers, support blocks, and contact switches;
the support seat is disposed on the support base, and the balance arm is connected to the support seat through the support seat bearing and makes a vertical motion with the support seat as a fulcrum;
the two dampers and the two force sensors are disposed between the support base and the balance arm;
the positioning plate is mounted on a grain tank of a harvester and is opposite to the clump weight, the positioning plate is provided with the support block and the contact switch; and
one side of the support base opposite to the clump weight is provided with the support block and the contact switch.

6. The grain yield monitoring apparatus with a function of measuring moisture content according to claim 5, wherein
the balance arm is in the balanced state when values of the two force sensors are equal or within a set threshold range and the clump weight triggers the contact switch on the positioning plate; and
after the calibration is completed and the grain in the metering cylinder is emptied, the clump weight falls onto the support block of the support base and triggers the contact switch.

7. The grain yield monitoring apparatus with a function of measuring moisture content according to claim 1, wherein at a sampling time interval Δt, the measured grain mass M′ of the grain flowing through the grain storage apparatus is as follows:
$${M}^{′} = g Δ {t}^{2} \cdot ρ S ;$$
within the mass calibration time period ΔT, the number of samplings of the flow sensor is recorded as n′, and a total measured grain mass M_{T}′ is as follows:
$${M}_{T}^{′} = {\sum }_{i = 1}^{{n}^{′}} g Δ {t}^{2} \cdot ρ {S}_{i} ,$$
where, ρ is grain density of a working plot under a condition of ideal moisture content, and Sᵢ represents an instantaneous cross-sectional area of the grain flow passing through the grain storage cylinder during i^{th} sampling of the flow sensor; and
determining whether to calibrate the grain mass obtained by sampling of the flow sensor within a certain time period before the calibration by judging a size between an error ΔM between the M_{T}′ and a calibrated grain mass m of the metering cylinder under the condition of ideal moisture content, and a predetermined value M_{ER}, then the total grain yield M_{T} is obtained as follows:
$${M}_{T} = {\sum }_{i = 1}^{{n}_{1}} {M}_{1 i} + {\sum }_{i = 1}^{{n}_{2}} {M}_{2 j} ,$$
where, n₁ is the total number of samplings of the flow sensor without calibration in a harvesting process; n₂ is the total number of samplings of the flow sensor with calibration in the harvesting process; M₁ᵢ represents a grain yield during i^{th} sampling without calibration; and M₂ⱼ represents a grain yield during j^{th} sampling with calibration.

8. The grain yield monitoring apparatus with a function of measuring moisture content according to claim 7, wherein
when the ΔM is less than or equal to the predetermined valueM_{ER}, no calibration is performed;
based on a recorded number n_{T1} of samplings of the flow sensor within a time period T before the calibration, the total number of samplings of the flow sensor within the mass calibration time period ΔT and the time period T before calibration is n′+n_{T1}, and a grain yield M₁ is as follows:
$${M}_{1} = {\sum }_{i = 1}^{{n}^{′} + {n}_{T 1}} g Δ {t}^{2} \cdot ρ {S}_{i} ,$$
when the ΔM is greater than the predetermined value M_{ER}, a grain yield within the time period T before the calibration is calibrated; the calibrated grain mass m is used as a grain yield within the mass calibration time period ΔT, and a calibration coefficient k_{ER} is as follows:
$${k}_{ER} = \frac{m}{{M}_{T}^{′}} ;$$
based on a recorded number n_{T2} of samplings of the flow sensor within the time period T before the calibration, a calibrated value M_{C}′ of the grain yield within the time period T before the calibration is as follows:
$${M}_{C}^{′} = {k}_{ER} {\sum }_{i = 1}^{{n}_{T 2}} g Δ {t}^{2} \cdot ρ {S}_{i} ;$$
and, a grain yield M₂ within the mass calibration time period ΔT and the time period T before calibration is as follows:
$${M}_{2} = m + {M}_{C}^{′} .$$

9. The grain yield monitoring apparatus with a function of measuring moisture content according to claim 1, wherein the moisture content of the grain obtained based on the grain volume is as follows:
$$\overline{w} = \frac{{\sum }_{i = 1}^{{n}_{w}} {w}_{i}}{{n}_{w}} ,$$
$$w = \frac{ρ {V}^{′} - m}{ρ {V}^{′}} \times 100 \% = \frac{{V}^{′} - V}{{V}^{′}} \times 100 \% ,$$
where, n_{w} is the total number of measurements of the moisture content of the grain; wᵢ is the moisture content of the grain measured for the i^{th} time; ρ is grain density of a working plot under the condition of ideal moisture content; V is grain volume of the working plot under the condition of the ideal moisture content; V′ is grain volume in a metering cylinder in the balanced state; and m is calibrated mass of the metering cylinder under the condition of the ideal moisture content.

10. A grain yield monitoring method with a function of measuring moisture content, using a grain yield monitoring apparatus with a function of measuring moisture content according to claim 1, and comprising:
when the balance arm is in a balanced state, obtaining calibrated grain mass based on mass of the clump weight;
obtaining measured grain mass of grain flowing through the grain storage apparatus within a mass calibration time period based on a grain flow signal from the flow sensor, and calibrating grain mass obtained by the flow sensor based on an error between the calibrated grain mass and the measured grain mass to obtain a total grain yield, wherein the mass calibration time period is a time period from the start of calibration until the balance arm is in the balanced state; and
when the balance arm is in the balanced state, obtaining grain volume in the metering apparatus based on a trigger position of the arrays of photoelectric sensors, and obtaining the moisture content of the grain based on the grain volume.

11. The grain yield monitoring apparatus with a function of measuring moisture content according to claim 3, wherein
at the start of the calibration, the metering cylinder flap motor drives the metering cylinder flap to rotate to close the bottom of the metering cylinder, and a push rod of the metering cylinder push-pull electromagnet extends out to fix the metering cylinder flap;
after the arrays of photoelectric sensors generate a trigger signal, the grain storage cylinder flap motor drives the grain storage cylinder flap to rotate to gradually reduce an opening degree of the bottom of the grain storage cylinder;
when the balance arm is in the balanced state, the grain storage cylinder flap motor drives the grain storage cylinder flap to rotate to close the bottom of the grain storage cylinder, and the grain storage cylinder push-pull electromagnet fixes the grain storage cylinder flap;
after the calibration is completed, the push rod of the metering cylinder push-pull electromagnet is controlled to retract, and the metering cylinder flap motor drives the metering cylinder flap to rotate to open the bottom of the metering cylinder; and
after the grain in the metering cylinder is emptied, the push rod of the grain storage cylinder push-pull electromagnet is controlled to retract, and the grain storage cylinder flap motor drives the grain storage cylinder flap to rotate to open the grain storage cylinder.
